(19) United States
(12) Patent Application Publication
(10) Pub. No.: US 2017/0219163 A1
(43) Pub. Date: Aug. 3, 2017

(54) TATTOO ARTIST WORKSTATION APPARATUS

(71) Applicants: Lisa MOMBERGER, Los Angeles, CA (US); Dakota GOMEZ, Los Angeles, CA (US)

(72) Inventors: Lisa MOMBERGER, Los Angeles, CA (US); Dakota GOMEZ, Los Angeles, CA (US)

(21) Appl. No.: 15/013,888

(22) Filed: Feb. 2, 2016

(51) Int. Cl. F16M 13/02; B65D 71/00; F16B 47/00

(52) U.S. Cl. CPC F16M 13/022; F16B 47/003; B65D 71/0085

(57) ABSTRACT

Provided is a disposable tattoo workstation apparatus. The tattoo workstation apparatus provides a clean and sterile workstation and decreases the time needed for tattoo workstation setup and tattoo preparation. The tattoo workstation apparatus includes a bib with a sterile upper surface on which tattooing supplies may be placed. The upper surface may be an absorbent material and a bottom surface provides a barrier that protects underlying surfaces from contamination. The bib may be a two-ply bib or a multiple-ply bib. The bib includes an adhesive on the bottom surface. Also provided is an ink cup plate which may be an integral piece formed by die casting or molding and includes a base plate and multiple ink cups. The base plate is affixed to the bib or disposed integrally within the bib and the ink cups extend above the upper surface of the bib for easy access.

### FIELD OF THE INVENTION

The present disclosure relates, most generally, to a workstation and workstation apparatus for a tattoo artist such as may be used in a tattoo parlor or at a tattoo workstation.

### BACKGROUND

The tattooing industry has experienced tremendous growth in recent years. The tattooing industry has become very competitive as tattoo artists and tattoo shops compete for the growing number of clients.

The tattoo artist and other technicians utilize a tattoo workstation at which the tools of the tattoo trade are maintained. Conventional tattoo workstations are subject to being very messy, unstable, unsanitary, dirty and disorganized. The tattoo workstation requires several components such as one or more tattoo machines and multiple tattoo inks that should be readily available and easily accessible to the tattoo artist. It is desirable to maintain a sterile, clean workstation with the various components readily accessible so that the tattooing process can be carried out in an efficient and sterile manner. It is further desirable to maintain the components in an orderly manner and to maintain a stable workstation.

In the tattooing industry, it takes time for the tattoo artist to set up and break down the workstation and it would be desirable to provide a workstation that can be quickly set up and broken down, and is a clean and organized workstation that remains in place and organized during the tattooing process. This is true in tattoo parlors and also in tattoo industry conventions and trade shows.

### SUMMARY OF THE INVENTION

To address the shortcomings of the art and in view of its purposes, the present disclosure provides a tattoo workstation including a bib with an adhesive on the bottom surface and a unitary ink cup plate member. The unitary ink cup plate member includes a plate portion and a plurality of ink cups integral with the plate portion. The unitary member is affixed to the bib. The bib with the underlying adhesive provides a non-slip and sanitary workstation.

According to another aspect, a tattoo workstation apparatus is provided. The tattoo workstation apparatus includes a two-ply bib. The two-ply bib includes an absorbent top surface and an adhesive on an opposed bottom surface. The tattoo workstation apparatus further includes a unitary ink cup plate member including a base plate disposed between the respective plies (sheets) and a plurality of ink cups integral with the base plate, in fixed position with respect to one another, and extending above the top surface. The unitary ink cup plate member is a single piece that may be molded or die-cast.

According to another aspect, a tattoo workstation apparatus is provided. The tattoo workstation apparatus provides a two-ply bib with an absorbent top sheet and a non-porous bottom sheet with an adhesive thereon. The tattoo workstation apparatus also includes a plurality of ink cups affixed to one another and to the top sheet, and extending from the top sheet.

### BRIEF DESCRIPTION OF THE DRAWING

The present invention is best understood from the following detailed description when read in conjunction with the accompanying drawing. It is emphasized that, according to common practice, the various features of the drawing are not necessarily to scale. On the contrary, the dimensions of the various features may be arbitrarily expanded or reduced for clarity. Like numerals denote like features throughout the specification and drawing.

FIG. 1 is a perspective view showing a tattoo workstation apparatus according to various embodiments of the disclosure;

FIG. 2 is a perspective view of a unitary member including a base plate and a plurality of ink cups according to an aspect of the disclosure;

FIG. 3 is an exploded view showing aspects of the tattoo workstation apparatus according to various embodiments of the disclosure;

FIG. 4 is a perspective view showing some features of the tattoo workstation apparatus according to various embodiments of the disclosure;

FIG. 5 is a perspective view showing another embodiment of a tattoo workstation apparatus according to the disclosure;

FIG. 6 is a perspective view showing another embodiment of a tattoo workstation apparatus according to the disclosure;

FIG. 7 is an exploded view showing components of a tattoo workstation apparatus according to embodiments of the disclosure;

FIG. 8 illustrates an adhesive arrangement on a bottom surface of a bib of a tattooing workstation apparatus according to various embodiments of the disclosure;

FIG. 9 illustrates another adhesive arrangement on a bottom surface of a bib of a tattooing workstation apparatus according to various embodiments of the disclosure; and

FIG. 10 is a perspective view showing features of a tattooing workstation apparatus according to aspects of the disclosure.

### DETAILED DESCRIPTION

Aspects of the disclosure provide a tattoo workstation and a tattoo workstation apparatus. The apparatus and workstation are advantageously used in the tattooing industry by tattoo artists such as in tattoo parlors. The disclosure is not, however, intended to be limited to such applications and not intended to be limited to the tattoo industry. In other embodiments, the workstation and apparatus of the disclosure find application in other arts and industries in which a craftsman or an artist or technician benefits from an organized, sterile, secure workstation in which multiple fluids such as ink, oils, paint or other fluids are required to be readily available and easily accessible. In various embodiments, the disclosure finds application for artists and other craftsmen.

The following description of the disclosure will be in terms of a tattoo workstation and a tattoo workstation apparatus but it should be understood that the disclosure is not limited to the tattooing art.

The disclosure provides a tattoo workstation apparatus which may be a single use, disposable tattoo workstation. The tattoo workstation provides a workstation with increased cleanliness and sterile properties and decreases the time needed for tattoo workstation setup and tattoo preparation. A medical/dental-type bib provides a sterile surface on which tattooing supplies may be placed and provides a barrier that protects underlying surfaces from contamination. The medical bib apparatus includes an adhesive on the bottom surface to ensure non-slip surface for the workstation. The medical bib apparatus may be advantageously placed on a table, countertop or any other suitable work surface. Also provided is an ink cup plate which may be an integral, i.e. single piece formed by die casting or other molding means and provides multiple ink cups. This allows the tattoo artist to dispense and utilize multiple desired inks disposed in a single ink cup plate. The workstation and workstation apparatus enable the tattoo artist to set up and break down the workstation in an expedited manner. This is true in tattoo parlors and especially advantageous in tattoo industry conventions and trade shows.

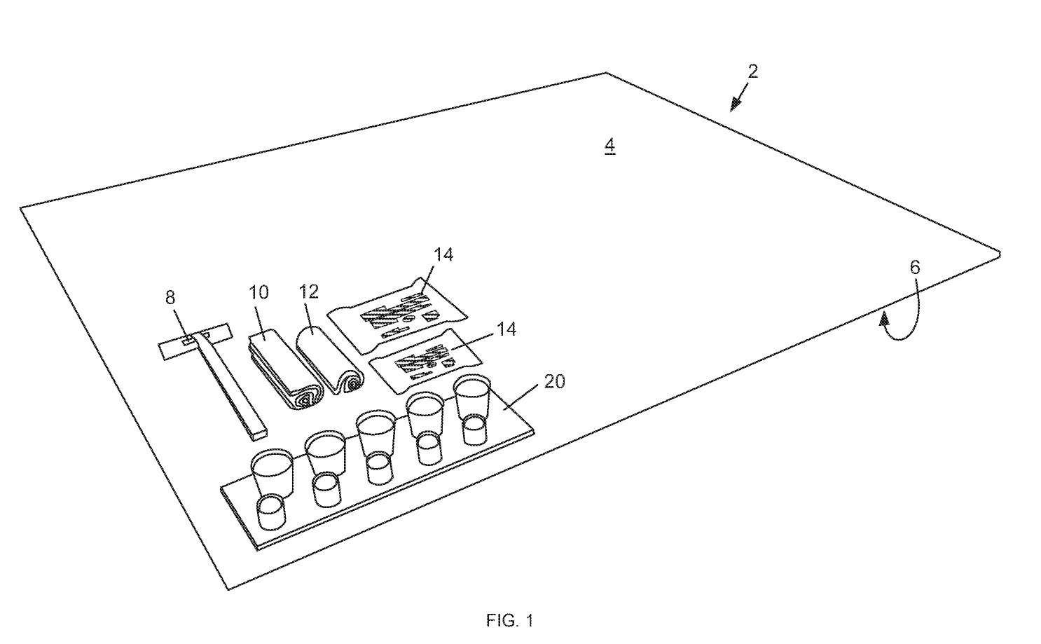

FIG. 1 is a perspective view showing a tattooing workstation apparatus according to various aspects of the disclosure. The apparatus includes bib 2 with top surface 4 and opposed bottom surface 6. Bottom surface 6 includes an adhesive that will be described and shown below. Bib 2 is a sterile bib and may be disposable. In some embodiments, bib 2 is formed of materials and components such as used for medical and dental bibs but other components and materials are used in other embodiments. In the illustrated embodiment, bib 2 is rectangular in shape but in other embodiments, bib 2 may take on other shapes such as round, ovoid, annular, oval, parabolic, triangular, trapezoidal or various other polygonal shapes. The size and shape of bib 2 may be customizable. Bib 2 may be described as a single sheet of material or a multiple-ply member formed of multiple layers of material and is a sterile material.

In various embodiments, top surface 4 is formed of an absorbent material such as paper, cloth or a combination thereof. Other absorbent materials may be used for top surface 4 in other embodiments. Top surface 4 may be formed of various porous materials. In some embodiments, top surface 4 may be formed of plastic or other suitable pliable materials. Bottom surface 6 may be formed of plastic, polymeric materials or other non-porous materials in various embodiments.

In some embodiments, bib 2 is a single-ply member with top surface 4 and bottom surface 6 and in such embodiments, bottom surface 6 may be a coating, laminate or other surface. In some embodiments, bib 2 is a two-ply bib and includes an upper ply or sheet including top surface 4 and a lower ply or sheet including bottom surface 6. In another embodiment, bib 2 may include multiple sheets or layers and may include an upper sheet being an absorbent sheet, a lower sheet being a plastic, polymeric or other non-porous sheet and one or more intermediate sheets. In the two-ply and other multiple-ply embodiments, the plies, i.e. sheets, are joined together using various suitable means such as but not limited to adhesives.

Bib 2 of the tattoo workstation may be of various dimensions and sized to accommodate the table, countertop or other surface upon which bib 2 will be placed. Bib 2 is sized to accommodate components such as shown in FIG. 1 and also additional components such as various bottles, papers, tattoo machines (sometimes referred to as tattoo guns) and other equipment used in the tattooing industry. In FIG. 1, components placed upon top surface 4 include razor 8, sanitary wipes 10, 12 and packets 14. In some embodiments, packets 14 include various medical ointments but packets 14 may include various other components used in the tattooing industry. Various other components are used in the tattooing industry and may be placed upon bib 2, but are not shown.

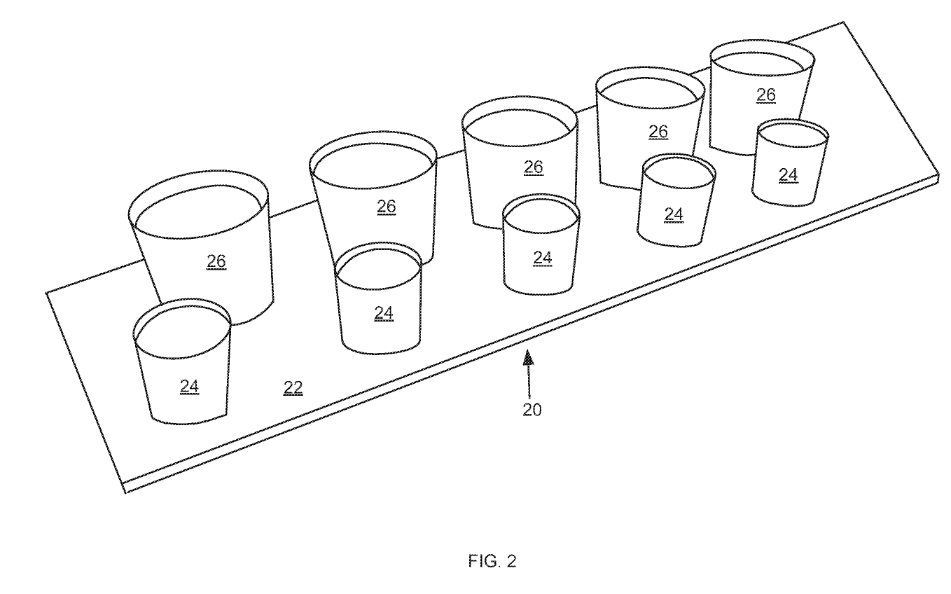

Ink cup plate 20 includes multiple ink cups and is affixed to top surface 4 of bib 2. In various embodiments, ink cup plate 20 is detachably affixed to top surface 4. Various adhesives may be used. In other embodiments, various other means for affixing ink cup plate 20 to top surface 4 of bib 2 may be used. In some embodiments Velcro may be used to affix and secure ink cup plate 20 to top surface 4. Ink cup plate 20 is shown in more detail in FIG. 2.

FIG. 2 shows ink cup plate 20. Ink cup plate 20 includes base plate 22 and multiple ink cups 24, 26. In some embodiments, ink cup plate 20 is an integral member, i.e. a single piece and in some embodiments, ink cup plate is a single molded or die cast member that includes base plate 22, ink cups 24 and ink cups 26. Ink cups 24 and ink cups 26 are in fixed position with respect to one another. Ink cups 24 and ink cups 26 are cylindrical in the illustrated embodiment but may take on other shapes in other embodiments. In the illustrated embodiment, base plate 22 is rectangular in shape but in other embodiments, base plate 22 take on any of various other shapes such as round, ovoid, annular, oval, parabolic, triangular, trapezoidal or other polygonal shapes

In the embodiment of FIG. 2, ink cup plate 20 includes two rows of ink cups: a first row of ink cups 24 and a second row of ink cups 26. In other embodiments, the ink cups may be arranged in a circular configuration or any of various other configurations, on base plate 22. In the illustrated embodiment, ink cups 24 are smaller than ink cups 26 but in other embodiments, ink cup plate 20 may include a number of ink cups all of the same size. In yet another embodiment, ink cup plate 20 may include ink cups of three or more sizes. Ink cup plate 20 may be formed of plastic, various polyurethanes, metal, wood or various other suitable rigid and nonporous materials. Ink cup plate 20 may be reusable.

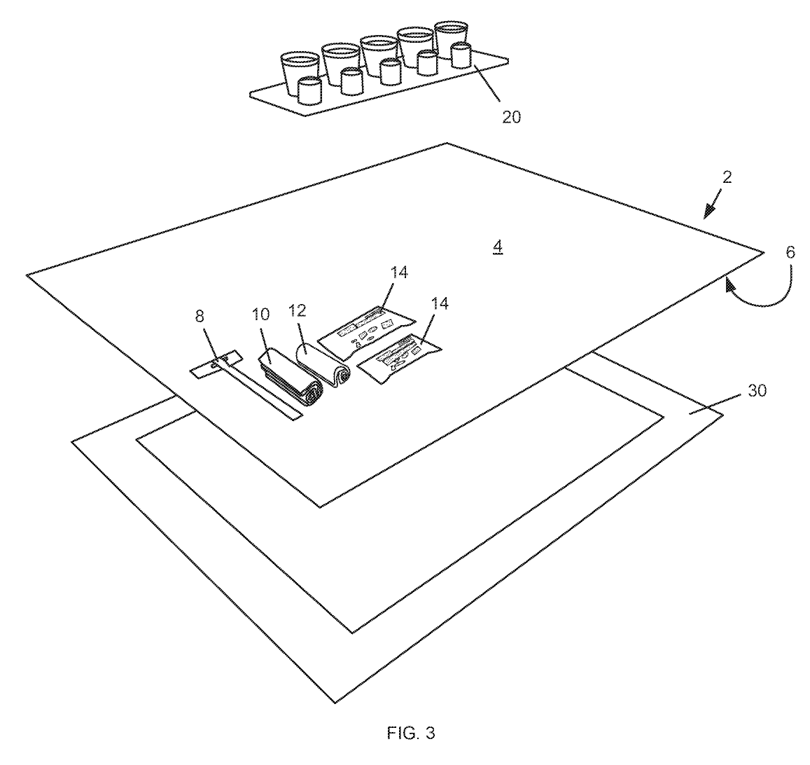

FIG. 3 is a perspective view showing components of the tattoo workstation apparatus embodiment shown in FIG. 1, in an exploded view. FIG. 3 shows bib 2 with top surface 4 and previously described components on top surface 4. FIG. 3 also shows ink cup plate 20. FIG. 3 also shows adhesive 30 that is joined to bottom surface 6 but is shown in exploded view in FIG. 3 separated from bib 2, for clarity. Adhesive 30 is a wide strip with a rectangular shape in the illustrated embodiment but takes on other forms in other embodiments as will be seen.

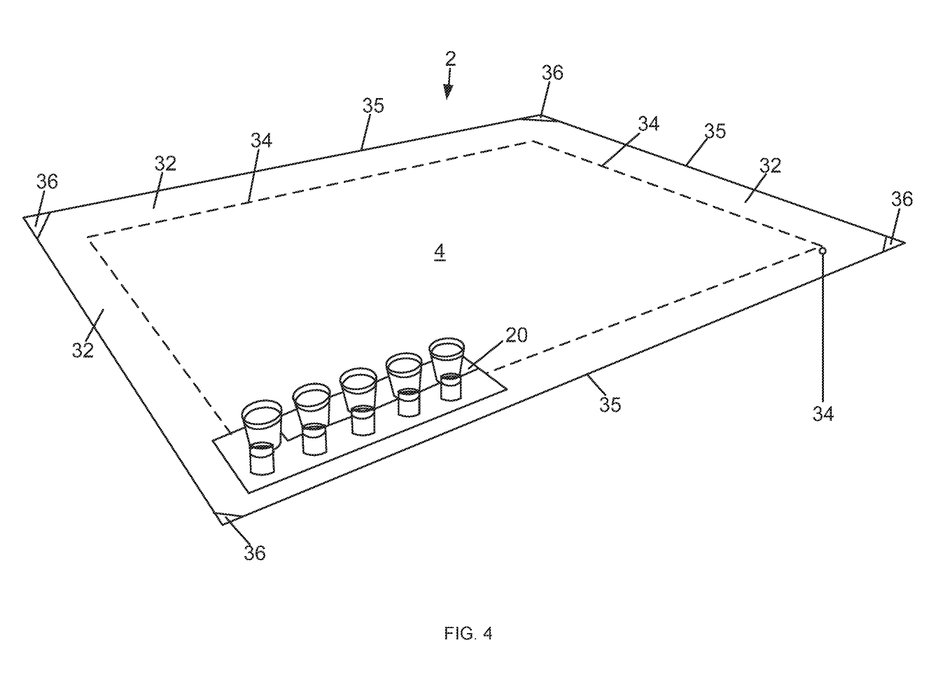

FIG. 4 shows components of a tattoo workstation apparatus according to the disclosure. FIG. 4 shows bib 2 with top surface 4 and ink cup plate 20 affixed to top surface 4. FIG. 4 also shows peripheral portion 32. Peripheral portion 32 represents the area on bottom surface 6 that includes an adhesive liner, i.e. adhesive 30 and peripheral portion 32 is identified by dashed lines 34. In some embodiments, adhesive 30 extends to edges 35 of bib 2 and in some embodiments adhesive 30 may be absent from corners 36 of bib 2. The absence of adhesive at corners 36 facilitates easy removal of bib 2 from the surface upon which it is placed. In other embodiments, the adhesive on bottom surface 6 is arranged in various other configurations and various suitable materials may be used as adhesive 30. In some embodiments, adhesive 30 is an adhesive material that preferably adheres to bottom surface 6 of bib 2 and is easily removable from a surface upon which bottom surface 6 of bib 2 is placed. In some embodiments, an adhesive such as an adhesive used in Post-it® notes may be used, but various other adhesives are used in other embodiments. In some embodiments, the adhesive is chosen to be an easily removable adhesive that does not permanently adhere to the surface upon which bib 2 is placed.

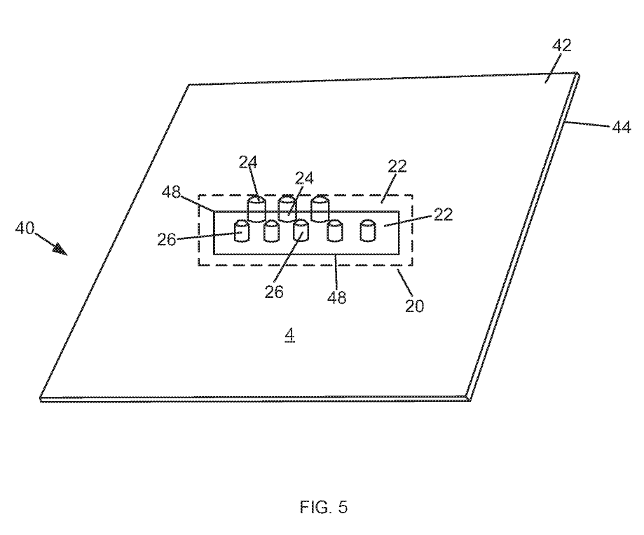

FIG. 5 shows aspects of another embodiment of the tattoo workstation apparatus of the disclosure. Bib 40 includes top surface 4 and bottom surface 6 as described above. Bib 40 is a two-ply bib including upper ply 42 and lower ply 44. Each of the plies—upper ply 42 and lower ply 44 may be considered and alternatively referred to, as a sheet or layer. Upper ply or sheet 42 includes top surface 4 which is sterilized and may be advantageously formed of an absorbent material as described above and lower ply or sheet 44 may be formed of plastic, various polymers or other non-porous sheets in other embodiments. Although not illustrated, additional sheets may be disposed between upper ply 42 and lower ply 44. FIG. 5 also shows ink cup plate 20 arranged such that base plate 22, identified by the dashed lines, is disposed between the respective plies 42, 44. Portions of ink cup plate 20 are thus disposed beneath upper ply 42. Upper ply 42 includes opening 48 through which portions of base plate 22 are exposed and through which ink cups 24, 26 extend. In the illustrated embodiment, ink cups 24, 26 extend through opening 48 of upper ply 42. It should be noted that the shape of base plate 22 and the shape of opening 48 are exemplary only and in other embodiments, either or both of base plate 22 and opening 48 may take on other shapes. Opening 48 may be shaped and sized with respect to base plate 22 in various embodiments.

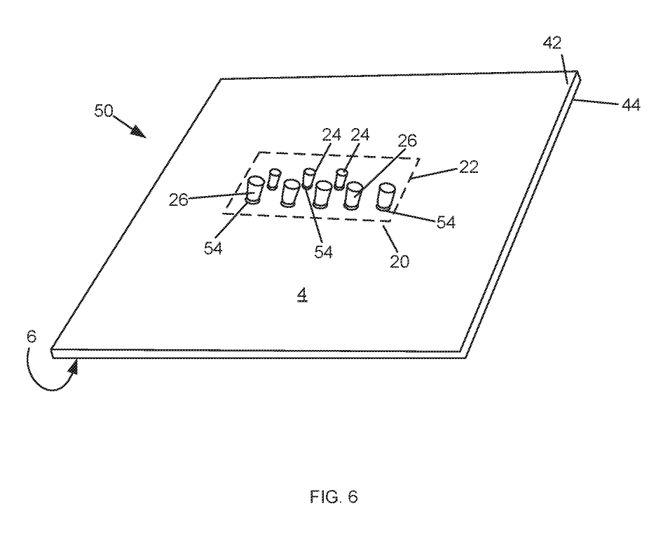

FIG. 6 shows another embodiment of a tattoo workstation apparatus according to some aspects of the disclosure. Bib 50 is a two-ply bib including upper ply or sheet 42 and lower ply or sheet 44, as described above in conjunction with FIG. 5. Base plate 22 of ink cup plate 20 is indicated by the dashed lines and is disposed between upper ply or sheet 42 and lower ply or sheet 44. Ink cups 24 and 26 each extend through a corresponding opening 54 in upper ply 42. In some embodiments, each opening 54 may be shaped and sized to have the same dimensions as the corresponding ink cup that extends through the opening.

Each of the embodiments shown in FIGS. 5 and 6 include an adhesive on bottom surface 6 of lower ply or sheet 44 as described above, and as will be shown below.

In other embodiments, arrangements other than the tattoo workstation apparatus embodiments of FIGS. 5 and 6 may be used. Various other openings or slits in upper ply 42 may be used to receive therein base plate 22 of ink cup plate 20. The various other openings or slits in upper ply 42 may take on various shapes and sized as may base plate 22. In some embodiments, upper ply 42 includes perforated portions that define the various openings or slits which may be formed by tearing at the perforated portions. In one embodiment, a simple slit may be used such that base plate 22 of ink cup plate 20 may be inserted into the slit and positioned between the plies, from above. In some embodiments, portions of upper ply 42 may extend upwardly alongside portions of ink cup plate 20. In various embodiments, the disclosure provides a multiple-ply bib with an absorbent top surface and a non-porous bottom surface with an adhesive on the bottom surface. Base plate 22 of ink cup plate 20 is disposed between the plies and at least beneath the upper ply and the ink cups formed integrally with base plate 22 extend through one or more openings, voids or slits formed in the upper ply such that the ink cups extend above the top surface of the bib for easy access. In various embodiments, base plate 22 may be affixed to either or both of upper ply 42 and lower ply 44 using various adhesives or other suitable means.

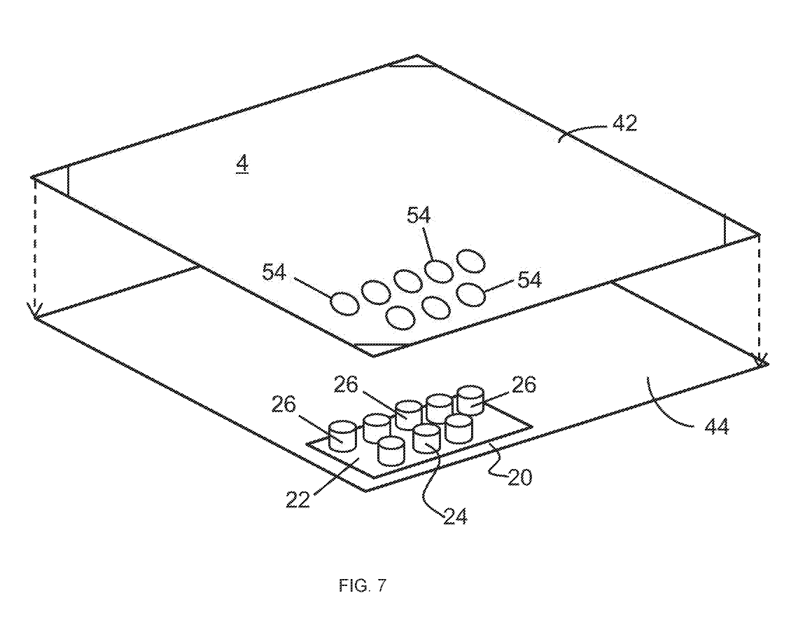

FIG. 7 is an exploded view showing aspects of a tattoo workstation apparatus embodiment, with some features similar to the embodiment shown in FIG. 6. In the exploded view of FIG. 7, upper ply 42 is shown above lower ply or sheet 44. Upper ply 42 includes multiple openings 54. Each opening 54 is adapted to receive a corresponding ink cup 24, 26 of ink cup plate 20. In some embodiments, openings 54 are each the same size and shape and in other embodiments, openings have different sizes and shapes. In the embodiment of FIG. 7, each opening 54 has a diameter that is the same as the outer diameter of ink cups 24 and 26. As described above, ink cup plate 20 is disposed between upper ply or sheet 42 and lower ply or sheet 44. In some embodiments, upper ply 42 is permanently affixed to lower ply 44 and in other embodiments, upper ply 42 is detachably affixed to lower ply 44 so that the respective plies can be separated and ink cup plate 20 may be easily removed.

The location of ink cup plate 20 with respect to the bib, will vary in various embodiments and in some embodiments, the upper ply 42 may include multiple slits or openings to accommodate various locations of ink cup plate 20 as desired by the tattoo artist. In some embodiments, the slits or openings may be identified by a removable perforated portion that may be torn to produce the slit or opening.

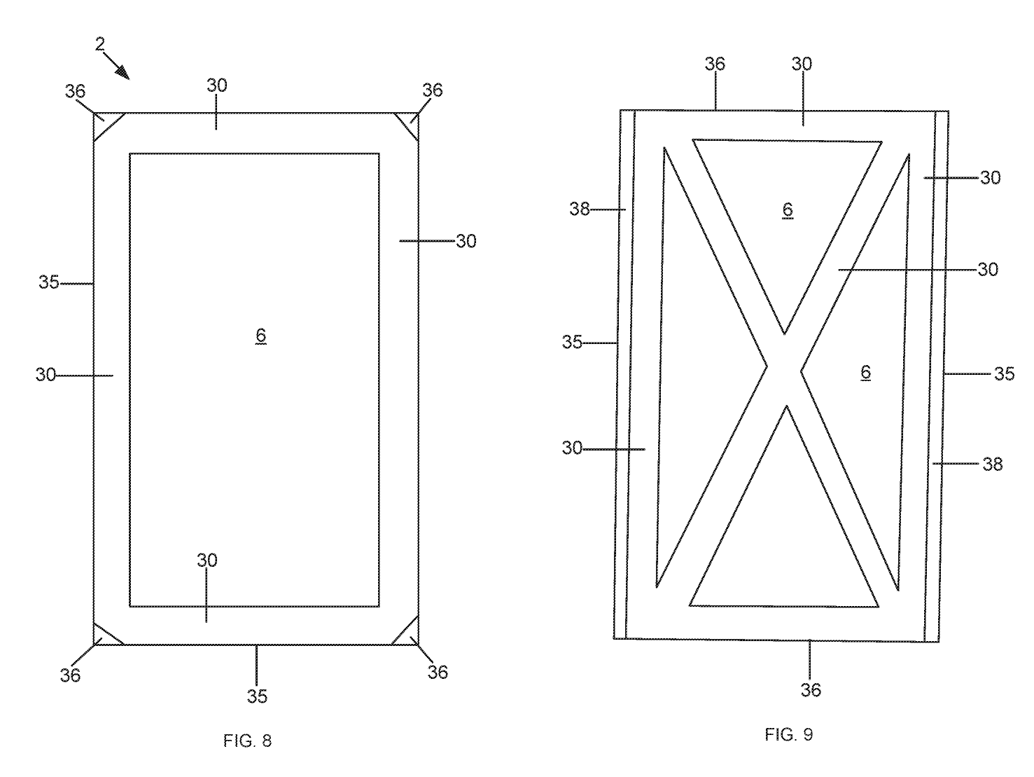

FIGS. 8 and 9 show two different embodiments of adhesive material on bottom surface 6 of bib 2. Bottom surface 6 represents the bottom surface of any of the bib embodiments shown or described above, e. g. bib 2, bib 40, bib 50 and the other bib embodiments described herein. In each of the illustrated embodiments, adhesive 30 is on portions of bottom surface 6 and bottom surface 6 also includes void areas void of adhesive 30. FIG. 8 shows bottom surface 6 and shows adhesive 30 that generally extends around the peripheral portion of bib 2 and extends to edges 35 but does not extend to corners 36. The central portion of bottom surface 6 of bib 2, i.e. the portion surrounded by adhesive 30, is void of adhesive. In other embodiments, such as shown in FIG. 9, other arrangements are used.

FIG. 9 shows adhesive 30 affixed to bottom surface 6 of bib 2. On two opposed sides of FIG. 9, adhesive 30 does not extend all the way to all edges 35 of bib 2. On two of the sides, void area 38, void of adhesive, exists between adhesive 30 and edge 35. In the adhesive arrangement of FIG. 9, adhesive 30 extends generally peripherally around bottom surface 6 of bib 2 and also includes criss-crossing diagonal portions in the central portion of bottom surface 6. The adhesive arrangements shown in FIGS. 8 and 9 are intended to be exemplary and not limiting of the disclosure and in various embodiments, various different arrangements such as a plurality of discrete adhesive sections may be used. In other embodiments, the entirety of bottom surface 6 includes adhesive 30. In another embodiment, adhesive 30 may be arranged in a plurality of concentrically arranged peripherally extending strips.

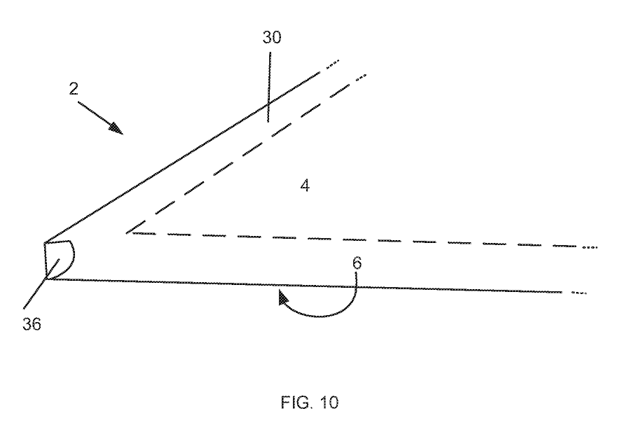

FIG. 10 is a perspective view showing a close up of a corner of bib 2. Adhesive 30 is disposed on bottom surface 6 of bib 2 except at corners 36 which function as tabs for easy removal of the tattooing workstation from the surface upon which it is disposed.

The word “exemplary” is used herein to mean “serving as an example or illustration.” Any aspect or design described herein as “exemplary” is not necessarily to be construed as preferred or advantageous over other aspects or designs.

The preceding merely illustrates the principles of the disclosure. While one or more embodiments of the invention have been described above, it should be understood that they have been presented by way of example only, and not by way of limitation. Likewise, the various figures or diagrams may depict an example architectural or other configuration for the disclosure, which is done to aid in understanding the features and functionality that can be included in the disclosure. The disclosure is not restricted to the illustrated example configurations, but can be implemented using a variety of alternative architectures and configurations. It will thus be appreciated that those skilled in the art will be able to devise various arrangements which, although not explicitly described or shown herein, embody the principles of the disclosure and are included within its spirit and scope. Furthermore, all examples and conditional language recited herein are principally intended expressly to be only for pedagogical purposes and to aid the reader in understanding the principles of the disclosure and the concepts contributed by the inventor to furthering the art, and are to be construed as being without limitation to such specifically recited examples and conditions. All statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the invention has been described in terms of exemplary embodiments, it is not limited thereto. Rather, the appended claims should be construed broadly, to include other variants and embodiments of the disclosure, which may be made by those skilled in the art without departing from the scope and range of equivalents of the invention.

What is claimed is:

1. A tattoo workstation comprising:
a bib with an adhesive on a bottom surface thereof; and
a unitary member with a plate portion and a plurality of ink cups integral with said plate portion, said unitary member affixed to said bib.

2. The tattoo workstation as in claim 1, wherein said bib is a disposable bib and includes an opposed absorbent upper surface.

3. The tattoo workstation as in claim 2, wherein said bib is a two-ply bib and includes an upper sheet with said absorbent upper surface, said upper sheet comprising one of paper and cloth.

4. The tattoo workstation as in claim 1, wherein said adhesive extends peripherally around said bottom surface and said unitary member is affixed to an opposed upper surface of said bib.

5. The tattoo workstation as in claim 1, wherein said adhesive extends peripherally around said bottom surface and extends to at least some edges of said bottom surface, and said bottom surface further comprises void areas void of said adhesive, said void areas including corners of said bib.

6. The tattoo workstation as in claim 1, wherein said bib includes an opposed absorbent upper surface, said plate portion is disposed beneath said absorbent upper surface and is partially covered by said absorbent upper surface of said bib.

7. The tattoo workstation as in claim 6, wherein said plurality of ink cups extend through an opening in said absorbent upper surface and above said absorbent upper surface.

8. The tattoo workstation as in claim 1, wherein said adhesive preferably adheres to said bib and is detachable from a further surface upon which said bib is placed.

9. The tattoo workstation as in claim 1, wherein said plurality of ink cups includes ink cups arranged in rows and having different sizes.

10. A tattoo workstation apparatus comprising a two-ply bib with an absorbent top surface and an adhesive on an opposed bottom surface thereof, a unitary member including a base plate and a plurality of ink cups integral with said base plate and in fixed position with respect to one another, said base plate disposed between said respective plies and said plurality of ink cups extending above said top surface.

11. The tattoo workstation apparatus as in claim 10, wherein a top ply of said two-ply bib comprises an absorbent sheet and a bottom ply of said two-ply bib comprises a sheet formed of a non-porous material and having said adhesive thereon.

12. The tattoo workstation apparatus as in claim 11, wherein said top ply includes a plurality of openings and said plurality of ink cups extend through said plurality of openings.

13. The tattoo workstation apparatus as in claim 12, wherein said plurality of openings include openings of different sizes and said plurality of ink cups include ink cups of different sizes, each of said openings having a diameter equal to the outer diameter of the ink cup extending through said opening.

14. The tattoo workstation apparatus as in claim 10, wherein said top ply includes an opening and said plurality of ink cups extend through said opening.

15. The tattoo workstation apparatus as in claim 10, wherein said opposed bottom surface includes adhesive portions extending peripherally around said bottom surface and void portions void of said adhesive, said void portions including centrally disposed void portions and corner void portions disposed at corners of said bib and said adhesive preferably adheres to said bib and is detachable from a further surface upon which said two-ply bib is placed.

16. The tattoo workstation apparatus as in claim 10, wherein a top ply of said two-ply bib includes removable perforated portions.

17. The tattoo workstation apparatus as in claim 16, wherein said opposed bottom surface includes adhesive portions extending peripherally around said bottom surface and void portions void of said adhesive, said void portions including centrally disposed void portions and corner void portions disposed at corners of said bib; and
said plurality of ink cups includes ink cups arranged in rows, said ink cups having different sizes.

18. A tattoo workstation apparatus comprising a two-ply bib with an absorbent top surface, an opposed bottom surface with an adhesive thereon and a plurality of ink cups in fixed position with respect to one another and attached to and extending upwardly from said absorbent top surface.

19. The tattoo workstation apparatus as in claim 18, wherein a top ply of said two-ply bib comprises an absorbent sheet and a bottom ply of said two-ply bib comprises a sheet formed of a non-porous material and having said adhesive thereon, said plurality of ink cups form an integral unit with a base plate disposed between said upper ply and said bottom ply.

20. The tattoo workstation apparatus as in claim 19, wherein said integral unit is formed of plastic, said plurality of ink cups extend through a plurality of openings in said upper ply and said plurality of ink cups include ink cups of different sizes.
